(19) United States
(12) Patent Application Publication
(10) Pub. No.: US 2008/0256265 A1
(43) Pub. Date: Oct. 16, 2008

(54) Display hard disk drive status on external display

(75) Inventors: SungChang Lee, San Jose, CA (US); Joerg Ferber, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/787,601

(22) Filed: Apr. 16, 2007

(51) Int. Cl. G06F 1/18

(52) U.S. Cl. 710/19

(57) ABSTRACT

A system with a visual display that provides an indication of a reliability of a hard disk drive of the system. The visual display may display the number of sector reallocations that have been performed by the disk drive. The display is coupled to a system housing so that a user can readily determine the reliability of the disk drive.

### BACKGROUND OF THE INVENTION

1. Field of the Invention

The present invention relates to a system that provides a visual indication of a reliability of a hard disk drive.

2. Background Information

Hard disk drives are used in various systems such as computers, music players, etc. The drives are used as non-volatile memory that can store large amounts of data.

A conventional disk drive includes one or more disks that are rotated by a spindle motor. Magnetic heads are used to write and read data from the surfaces of the disks. The disk surfaces are organized into a series of concentric radial tracks. Each track is divided into a plurality of sectors. Incoming data is mapped to available sectors for storage. The drives typically have self-diagnostic functions that can determine whether a sector is bad. Bad sectors are reallocated and not used by the disk drive.

The capacity and reliability of a disk drive can be ascertained by viewing certain graphical user interfaces provided by the system operating system. Accessing such data requires a certain level of knowledge and skill about the operating system and systems in general. Lexar Media has marketed a USB flash drive that includes a visual display that provides the memory capacity of the drive. This product does not provide a ready means for viewing drive reliability.

A disk drive “crash” is an undesirable event that may result in the loss of data. It would be desirable to have a system that readily provides an indication of disk drive reliability to the user of the system.

### BRIEF SUMMARY OF THE INVENTION

A system that contains a hard disk drive. The system includes a visual display that is coupled to a housing and displays an indication of a reliability of the hard disk drive.

### BRIEF DESCRIPTION OF THE DRAWINGS

FIG. 1 is an illustration showing a computer;

FIG. 2 is a schematic of the computer;

FIG. 3 is an alternate embodiment of a visual display of the computer;

FIG. 4 is a top view of an embodiment of a hard disk drive;

FIG. 5 is a schematic of an electrical system of the hard disk drive.

### DETAILED DESCRIPTION

Disclosed is a system with a visual display that provides an indication of a reliability of a hard disk drive of the system. The visual display may display the number of sector reallocations that have been performed by the disk drive. The display is coupled to a system housing so that a user can readily determine the reliability of the disk drive.

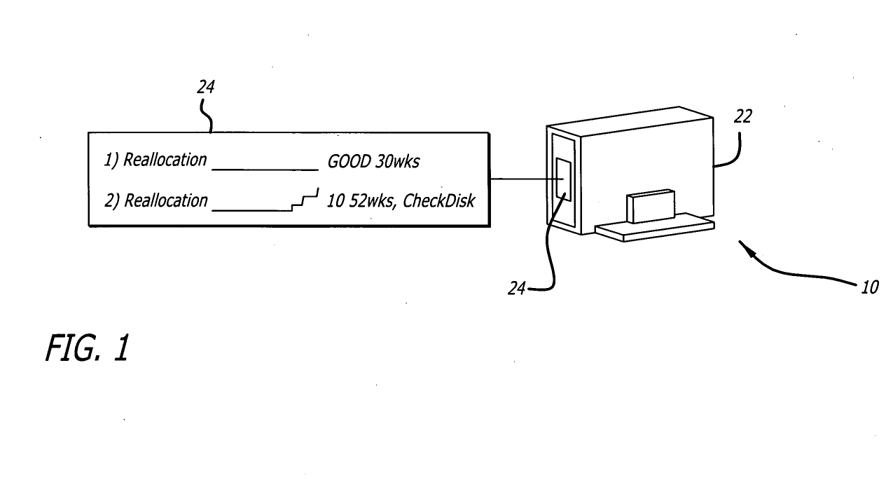

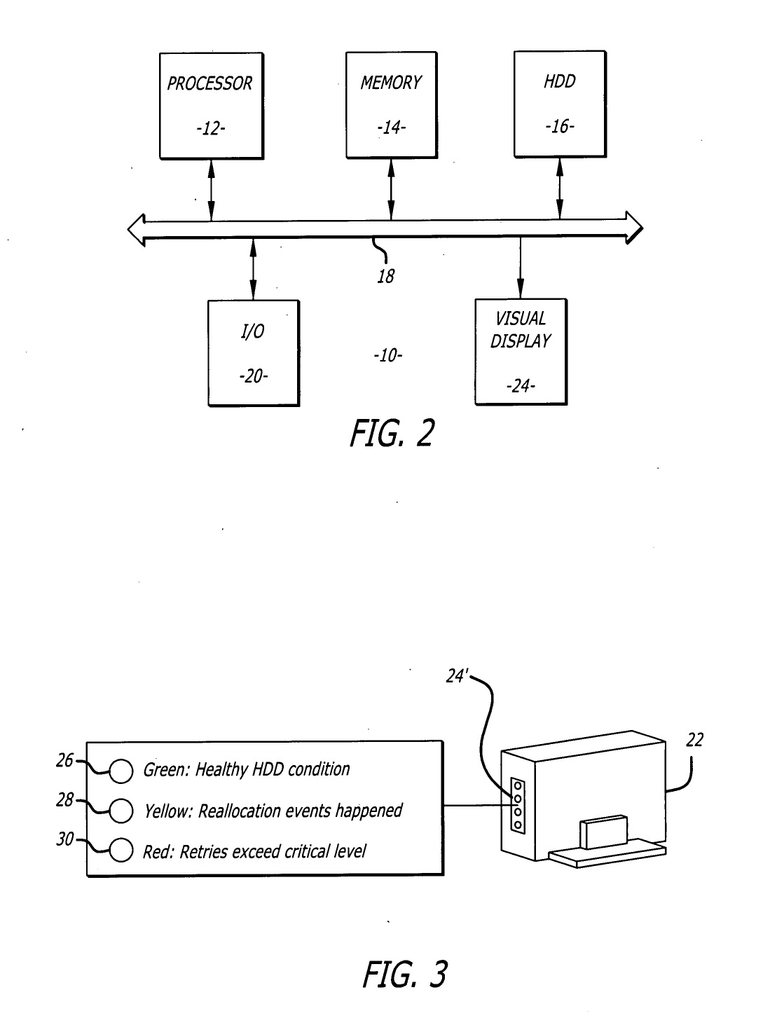

Referring to the drawings more particularly by reference numbers, FIGS. 1 and 2 show an embodiment of a system 10. By way of example, the system 10 can be a personal computer. Although a personal computer is shown and described, it is to be understood that the system can be a music player, personal digital assistant, digital video recorder, hard disk drive enclosure, or any other system that utilizes a hard disk drive.

The system 10 may include a microprocessor 12, one or more memory devices 14 and a hard disk drive 16. These components may be coupled to a bus 18. The system 10 may also have one or more input/output ports 20 for connection to a monitor, keyboard, printer, etc.

The disk drive 16 may contain software that determines whether a disk sector is bad and reallocates the sector. By way of example, the disk drive may have a SMART log processing software that identifies and reallocates bad sectors. Alternatively, the processor 12 may operate software that identifies and reallocates bad sectors. The bad sectors may be counted and listed in a log.

The system 10 includes a housing 22 that encloses the various hardware components, such as the processor 12, memory 14 and disk drive 16. A visual display 24 is attached to the outside of the housing 22. The visual display 24 provides an indication of the reliability of the disk drive. For example, the visual display 24 may display the number of sector reallocations of the drive.

FIG. 1 shows two possible displays. If there are no reallocations the display 24 may show a flat line and a text message “GOOD”. The display 24 may also indicate the number of weeks “30 wks” that the disk drive has been monitored. If there have been reallocations, the line can change levels and if the reallocations exceed a threshold a “CHECK DISK” text message may be provided by the display 24. The visual display 24 is preferably located on a surface of the housing 22 that can be readily accessed and viewed by a user of the system. This allows the user to easily determine the reliability of the disk drive by merely looking at the visual display 24. The user can take appropriate steps if the disk drive needs maintenance.

FIG. 3 shows an alternate embodiment of a visual display 24′ that has a plurality of reliability status lights 26, 28 and 30. The lights 26, 28 and 30 are preferably located on a surface that is readily accessible to a user. The illumination of light 26 may be indicative of a disk drive with no sector reallocations. Illumination of light 28 may indicate that sector reallocations have occurred. Light 30 may provide an indication that the sector reallocations have exceeded a threshold number and appropriate action is required.

The visual displays 24 and/or 24′ may be liquid crystal devices (“LCDs”). Alternatively, the visual displays 24 and/or 24′ may be electronic paper (“E-paper”). The visual displays 24 and/or 24′ may be driven by the system processor 12, or directly by the disk drive 16.

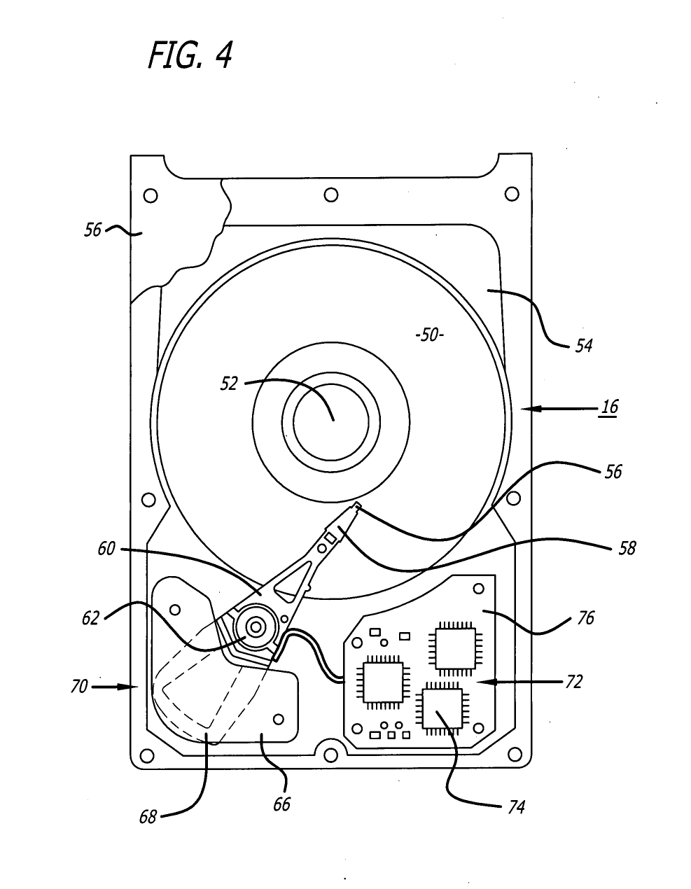

FIG. 4 shows an embodiment of a hard disk drive 10. The disk drive 10 may include one or more magnetic disks 50 that are rotated by a spindle motor 52. The spindle motor 52 may be mounted to a base plate 54. The disk drive 16 may further have a cover 56 that encloses the disks 50.

The disk drive 16 may include a plurality of heads 56 located adjacent to the disks 50. The heads 56 may have separate write and read elements (not shown). The write element magnetizes the disk 50 to write data. The read element senses the magnetic fields of the disks 50 to read data. By way of example, the read element may be constructed from a magneto-resistive material that has a resistance which varies linearly with changes in magnetic flux.

Each head 56 may be gimbal mounted to a flexure arm 58 as part of a head gimbal assembly (HGA). The flexure arms 58 are attached to an actuator arm 60 that is pivotally mounted to the base plate 54 by a bearing assembly 62. A voice coil 64 is attached to the actuator arm 60. The voice coil 64 is coupled to a magnet assembly 66 to create a voice coil motor (VCM) 68. Providing a current to the voice coil 64 will create a torque that swings the actuator arm 58 and moves the heads 56 across the disks 50.

The hard disk drive 16 may include a printed circuit board assembly 72 that includes a plurality of integrated circuits 74 coupled to a printed circuit board 76. The printed circuit board 74 is coupled to the voice coil 68, heads 56 and spindle motor 52 by wires (not shown).

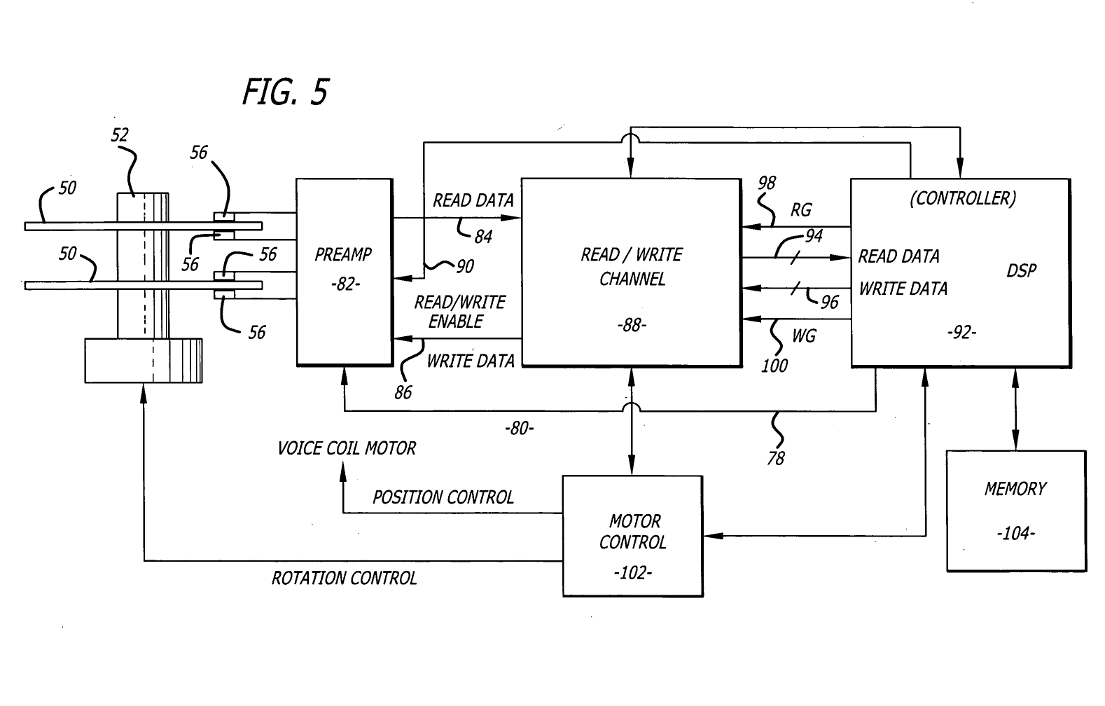

FIG. 5 shows an embodiment of an electrical circuit 80 for reading and writing data onto the disks 50. The circuit 80 may include a pre-amplifier circuit 82 that is coupled to the heads 56. The pre-amplifier circuit 82 has a read data channel 84 and a write data channel 86 that are connected to a read/write channel circuit 88. The pre-amplifier 82 also has a read/write enable gate 90 connected to a controller 92. Data can be written onto the disks 50, or read from the disks 50 by enabling the read/write enable gate 90.

The read/write channel circuit 88 is connected to the controller 92 through read and write channels 94 and 96, respectively, and read and write gates 98 and 100, respectively. The read gate 98 is enabled when data is to be read from the disks 50. The write gate 100 is to be enabled when writing data to the disks 50. The controller 92 may be a digital signal processor that operates in accordance with a software routine, including a routine(s) to write and read data from the disks 50. The read/write channel circuit 88 and controller 92 may also be connected to a motor control circuit 102 which controls the voice coil motor 70 and spindle motor 52 of the disk drive 16. The controller 92 may be connected to a non-volatile memory device 104. By way of example, the device 104 may be a read only memory (“ROM”) that contains instructions that are read by the controller 92.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system that contains a hard disk drive, comprising:
a hard disk drive;
a housing coupled to said hard disk drive; and,
a visual display that is coupled to said housing and displays an indication of a reliability of said hard disk drive.

2. The system of claim 1, wherein said hard disk drive contains a disk with a plurality of sectors, said visual display provides an indication of a number of reallocated sectors.

3. The system of claim 1, wherein said visual display provides a plurality of hard disk drive reliability states.

4. The system of claim 3, wherein said reliability states include no sector reallocations, some sector reallocations, and sector reallocations that exceed a threshold.

5. The system of claim 1, wherein said visual display includes an E-paper display.

6. The system of claim 1, wherein said housing is a computer housing.

7. A computer, comprising:
a housing;
a microprocessor located within said housing;
a hard disk drive located within said housing; and,
a visual display that is coupled to said housing and displays an indication of a reliability of said hard disk drive.

8. The computer of claim 7, wherein said hard disk drive contains a disk with a plurality of sectors, said visual display provides an indication of a number of reallocated sectors.

9. The computer of claim 7, wherein said visual display provides a plurality of hard disk drive reliability states.

10. The computer of claim 9, wherein said reliability states include no sector reallocations, some sector reallocations, and sector reallocations that exceed a threshold.

11. The computer of claim 7, wherein said visual display includes an E-paper display.

12. A method for providing a reliability status of a hard disk drive within a system, comprising:
determining a reliability of a hard disk drive coupled to a housing; and,
displaying an indication of the reliability of the hard disk drive on a visual display coupled to the housing.

13. The method of claim 12, wherein the hard disk drive contains a disk with a plurality of sectors, and the visual display provides an indication of a number of reallocated sectors.

14. The method of claim 12, wherein the visual display provides a plurality of hard disk drive reliability states.

15. The method of claim 14, wherein the reliability states include no sector reallocations, some sector reallocations, and sector reallocations that exceed a threshold.
